(19) United States
(12) Patent Application Publication
(10) Pub. No.: US 2009/0254271 A1
(43) Pub. Date: Oct. 8, 2009

(54) METHOD AND APPARATUS FOR NAVIGATION SERVICE

(76) Inventors: Ki-Uk Kyung, Daejeon (KR); Jun-Seok Park, Daejeon (KR); Ji-Eun Park, Seoul (KR); Dong-Won Han, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/439,240

(22) PCT Filed: Aug. 29, 2007
(86) PCT No.: PCT/KR2007/004156

§ 371 Date: Feb. 27, 2009

(30) Foreign Application Priority Data
Aug. 30, 2006 (KR) 10-2006-0083103

(51) Int. Cl. G01C 21/34

(52) U.S. Cl. 701/208

(57) ABSTRACT

A method and apparatus for providing a safe and accurate navigation service using a tactual sense and an olfactory sense are provided. In the method, tactual information created according to navigation information displayed on a navigation map composed by a terminal based on collected navigation information is received. Then, a plurality of pins are controlled to make vertical movements according to a directional stimulation and frequency amplitude variation obtained from the received tactual sense information.

### TECHNICAL FIELD

The present invention relates to a method and apparatus for providing a navigation service and, more particularly, to a method and apparatus for providing a safe and accurate navigation service using a tactual sense and an olfactory sense in an environment having the difficulty to obtain accurate voice and visual information.

### BACKGROUND ART

Moving objects, for example, vessels, air crafts, and vehicles, generally use a navigation system or a global positioning system (GPS) to detect a current location, a current speed, and a traveling path, or to receive a navigation service.

The navigation system creates a traveling path to a destination with a related map using information received from the server of a navigation service provider, and guides a user or a driver using voice and visual information.

The conventional navigation system requires the drivers of vessels, air crafts, and vehicles to watch the visual navigation service such as the map or the traveling path displayed on the screen of the navigation system while they are driving. It is very unsafe and may cause accidents. Also, the drivers may have difficulty to listen the voice navigation service due to the noise. In order to enable a user to concentrate on driving a vehicle for preventing the accident, various technologies were introduced. As an example, a method of mounting a navigation system near by a driver seat was introduced.

Since the conventional technologies are just simple control devices using voice and visual information, the driver receives the navigation service therefrom with some unsolved problems.

Meanwhile, a mobile terminal providing a navigation service was introduced, and the related various technologies were introduced. The mobile terminal, however, provides only voice and visual navigation service like as the conventional navigation system. Therefore, a blind person and a deaf person cannot use the navigation service provided through the mobile terminal. Also, the normal person has the difficulty to receive an accurate navigation service through the mobile terminal if the user is in an environment that disturbs the user to concentrate thereon.

Therefore, there is a demand for a technology for receiving an intuitive, safe and accurate navigation service using another information except the voice and visual information in an environment disturbing a driver or a user to concentrate.

### DISCLOSURE OF INVENTION

### Technical Problem

The present invention has been made to solve the foregoing problems of the prior art and therefore an aspect of the present invention is to provide a method and apparatus for intuitively providing a navigation service using a tactual sense and an olfactory sense in an environment where a user or a driver cannot concentrate on a map and a navigation service.

### Technical Solution

According to an aspect of the invention, the invention provides a method for providing navigation service including: receiving tactual information created according to navigation information displayed on a navigation map composed by a terminal based on collected navigation information; and controlling a plurality of pins to make vertical movements according to a directional stimulation and frequency amplitude variation obtained from the received tactual sense information.

According to another aspect of the invention, the invention provides a method for providing navigation service including: at a terminal for a navigation service, creating a navigation map by collecting information for the navigation service; performing the navigation service by providing visual and voice information created based on navigation information displayed on the created navigation map; creating and combining tactual and olfactory sense information according to the navigation information displayed on the created navigation map; and transmitting the combined tactual and olfactory sense information to a pen type device for providing a navigation service to the user by stimulating the senses of the user according to the created tactual and olfactory sense information.

According to still another aspect of the invention, the invention provides an apparatus for providing a navigation service including a terminal. The terminal has a controlling unit for collecting information for navigation service and creating a navigation map according to the collected information; a display unit for displaying navigation information at the created navigation map; a speaker for informing the navigation information displayed on the navigation map through voice; an information generating unit for generating the navigation information displayed on the navigation map as tactual and olfactory sense information; and a wireless communication unit for transmitting the tactual and olfactory information to a pen type device for providing a navigation service to the user according to the created tactual and olfactory information.

According to further another aspect of the invention, the invention provides an apparatus for providing a navigation service comprising a pen type device. The pen type device has: a wireless communication unit for receiving tactual sense information from a terminal that creates a navigation map by collecting information for a navigation service and transmits tactual sense information created according to navigation service information displayed on the created navigation map; a texture reproducing unit for arranging a plurality of pins on a predetermined plane, and stimulating a tactual sense of a user by driving corresponding pins to make vertical movement according to traveling direction information obtained from the received tactual sense information; and a controlling unit for controlling the vertical movement of the corresponding pins by transferring traveling direction information to the texture reproducing unit.

### Advantageous Effects

A navigation service providing system according to the certain embodiment of the present invention receives traffic and safety information and provides accurate safe navigation service to the user through the tactual sense of the user although the user has difficulty to accurately receive voice or visual information. Also, the navigation service providing system according to the certain embodiment of the present invention provides fragrance information related to peripheral environment to a user in order to enable the user to recognize intermediate points based on the provided fragrance without looking around the peripheral environment. Therefore, the advertisement effect thereof can be maximized.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating function blocks for describing interaction between a terminal and a sensory feedback device in a navigation service providing system according to an embodiment of the present invention;

FIG. 2 is a diagram illustrating an external shape of the pen type sensory feedback device for providing a navigation service according to an embodiment of the present invention;

FIG. 3 is a diagram illustrating the internal structure of the pen type device shown in FIG. 2;

FIG. 4 is a diagram illustrating a pen type device applied to a navigation service providing system according to an embodiment of the present invention;

FIG. 5 is a diagram illustrating a terminal and a pen type device mounted at a steering of a vehicle according to an embodiment of the present invention;

FIG. 6 is a diagram illustrating a method of using tactual information provided to a texture reproducing unit 110 according to an embodiment of the present invention; and

FIG. 7 is a flowchart illustrating a method for providing a navigation service according to an embodiment of the present invention.

### BEST MODE FOR CARRYING OUT THE INVENTION

Certain embodiments of the present invention will now be described in detail with reference to the accompanying drawings. Like numeral references denote like elements throughout the accompanying drawings. In order to clearly describe the present invention, the description of the well known functions and elements may be omitted.

A system for providing a navigation service according to an embodiment of the present invention includes a navigation device, hereinafter a terminal, for creating a map using information received through cooperating with a telemetric system and providing a navigation service using voice and visual information, and a pen type device disposed near by the driver for providing the navigation service using other senses including a tactual sense and an olfactory sense. In the navigation service providing system according to the present embodiment, the structures of the terminal and the pen type device will be described with reference to the accompanying drawings. At first, the functional inside structures thereof will be described.

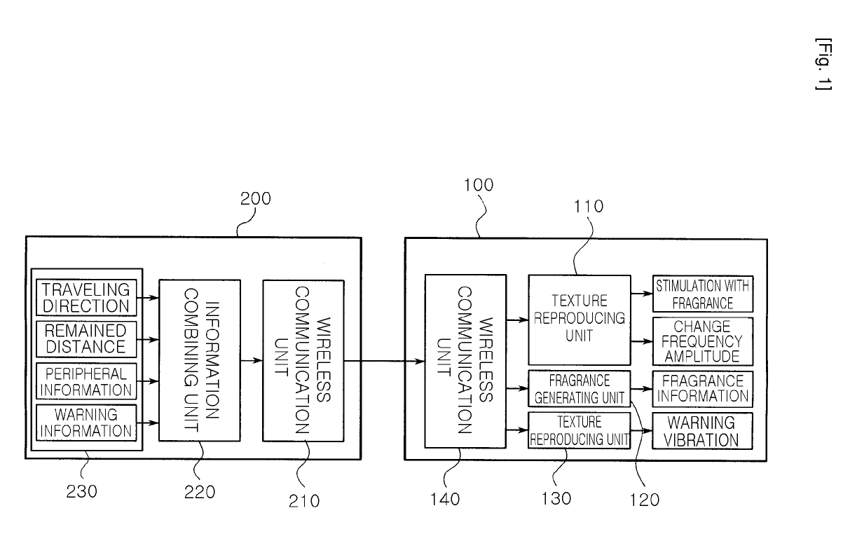

FIG. 1 is a block diagram illustrating function blocks for interacting a terminal and a pen type device in a navigation service providing system according to an embodiment of the present invention.

Referring to FIG. 1, the navigation service providing system according to the present embodiment includes a pen type device 100, and a terminal 200. The pen type device 100 includes a texture reproducing unit 110, a fragrance generating unit 120, a vibrator 130, a wireless communication unit 140, and a controlling unit (not shown). The terminal 200 includes a wireless combining unit 210, an information combining unit 220, and an information creating unit 230. Although it is not shown in FIG. 1, the terminal 200 may include a display unit, a speaker, and a controller.

The texture reproducing unit 110 drives pins arranged to move in a vertical direction according to directional stimulation and frequency amplitude variation, which are obtained using information received through the wireless communication unit 140.

The fragrance generating unit 120 sprays fragrances previously stored in tanks using a small pump according to information received from the wireless communication unit 140. Herein, the fragrances stored in the tanks are selecting through a controlling unit as various scent information corresponding to environments including peripheral buildings or places in advance, and the scent information are stored in the tanks.

The vibrator 130 is a motor, for example. The vibrator 130 receives warning information from the wireless communication unit 140 and transfers warning vibration to a user (driver).

The information combining unit 220 combines information generated from the information creating unit 230 and transfers the combined information to the wireless communication unit 210.

The information generating unit 230 creates voice and visual information through analyzing a signal received through telemetric system, and transfers the created visual information to the display unit and the speaker. The information generating unit 230 creates olfactory sense information for a traveling direction, a remained distance, peripheral information, and safety (warning) information, and transfers the created olfactory sense information to the information combining unit 220.

The wireless communication unit 210 transmits the combined information to the wireless communication unit 130 of the pen type device 100. Then, the wireless communication unit 140 analyzes the combined information and transfers the analyzing result to the texture reproducing unit 110, the fragrance generating unit 120, and the vibrator 130.

Hereinafter, the external structure of the pen type device 100 and the terminal 200 will be described.

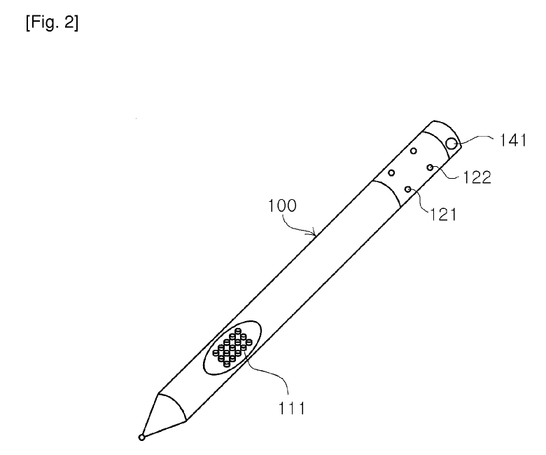

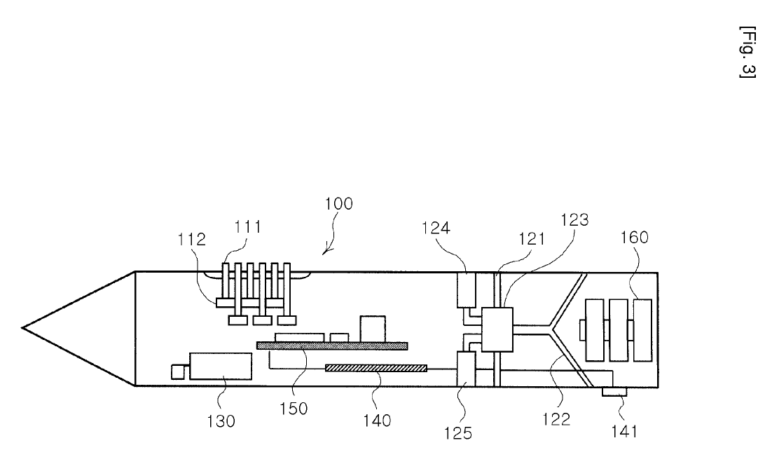

FIG. 2 is a diagram illustrating an external shape of the pen type device for providing a navigation service according to an embodiment of the present invention, and FIG. 3 is a diagram illustrating the internal structure of the pen type device shown in FIG. 2.

Referring to FIG. 2, the pen type device 100 includes a groove formed at a predetermined area thereof in order to enable a user to contact the groove with a finger. The groove has a plurality of holes. A plurality of pins 111 of the texture reproducing unit 110 are disposed to directly apply stimulations having displacement in vertical direction to the skin of the finger through the plurality of holes. The pen type device 100 includes a fragrant generating area of the fragrant generating unit 120 for spraying fragrant to other areas. The fragrant generating area includes an air inlet 121 for inhaling external air and a fragrance outlet 122 formed adjacent to the air inlet 121 for spraying fragrance. Also, the pen type device 100 includes an antenna 141 of the wireless communication unit 140 for communicating with other pen type device or an external terminal. The structure of the pen type device 110 will be described in detail with reference to FIG. 3.

Referring to FIG. 3, the pen type device 100 includes a vibrator 130 for transferring vibration to the skin of a user's finger, a wireless communication unit 140 for wireless communication, a controlling unit 150 for controlling internal electrical driving devices, and a power supply 160 for supplying power to the all internal electric elements.

The texture reproducing unit 110 of the pen type device 100 includes a plurality of pins 111 distributed on a predetermined plane and projected through the holes of the groove and micro pin motors 112 for driving the pins 111 to make in a linear motion. Each of the pins 111 may move in a vertical direction in response to the control of the controlling unit 150. The texture reproducing unit 110 controls each of the pins 111 to move up at a different height and at a different speed, thereby directly transforming the skin of the user's finger. Therefore, the texture reproducing unit 111 moves each of the pins 111 to enable a user to feel a predetermined texture such as patterns or roughness. It is preferable that the pins are arranged densely to transfer fine stimulation to the skin of a user.

The pin motor 112 can use a micro linear ultrasonic motor operated using low voltage. Also, a solenoid and a voice coil actuator can be used instead of the pin motor 112.

The fragrance generating unit 120 of the pen type device 100 includes an electric pump 123 connected to the air inlet 121 and the fragrance outlet 122 for inducing a pressure difference in order to externally spray fragrance, and a plurality of fragrance storing tanks 124, 125 for storing fragrance information. The fragrance outlet 122 sprays a gas with fragrance by the pressure difference included from the electric pump 216.

The vibrator 130 is a typical cylinder type eccentric motor. Also, a pan cake motor can be used as the vibrator 130.

The controlling unit 150 includes a processor, a memory, a current/voltage amplifier, an analog input/output element, and a digital input/output element. The controlling unit 150 controls inside functional elements.

Hereinafter, the structure of the terminal and a method for applying the pen type device will be described with reference to the accompanying drawings. Herein, the pen type device may use at a general navigation program like as a typical stylus pen.

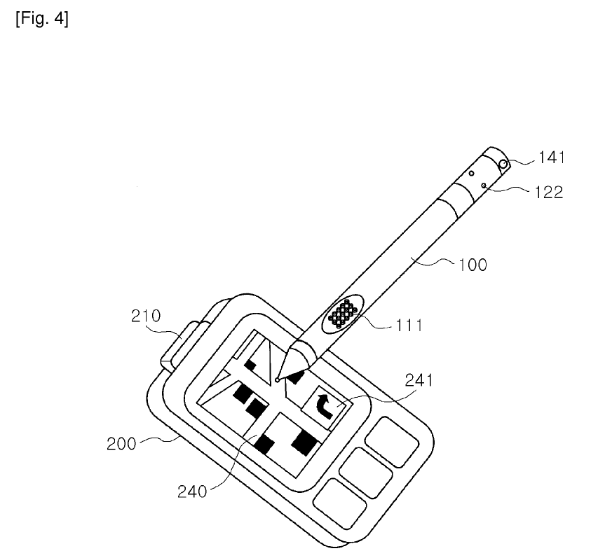

FIG. 4 is a diagram illustrating a pen type device applied to a navigation service providing system according to an embodiment of the present invention.

Referring to FIG. 4, the terminal 200 is a navigation apparatus. A user can carry the terminal 200 or the terminal 200 can be mounted at a predetermined position allowing the user to watch conveniently. As shown in FIG. 1, the wireless communication unit 210 and the display unit 240 can be disposed at the outer side of the terminal 200.

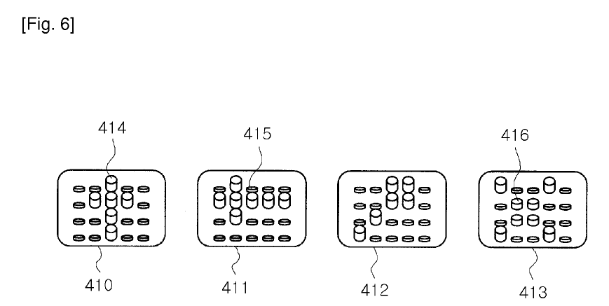

The display unit 240 obtains visual information by analyzing information collected at a controlling unit (not shown), and displays a map based on the obtained visual information. Then, the display unit 240 displays a traveling direction 241 to inform a direction to move from a current position. The traveling direction 241 and the visual information are transformed to auditory information by the controlling unit (not shown) and transferred to a user through the speakers. Also, the information generating unit 230 generates olfactory sense information of the traveling direction 241 and the visual information. Then, the information combining unit 220 combines the generated olfactory sense information, and the wireless communication unit 140 transmits the combined information to the pen type device 100. Then, the pen type device 100 receives the combined information from the wireless communication unit 140, and analyzes the received information. The controlling unit 150 of the pen type device 100 transfers corresponding information to the texture reproducing unit 111 and the fragrance outlet 113. Accordingly, the user can recognize the traveling direction and the remained distance by holding the pen type device 100 with the hands without watching the display unit 240. A method for transferring the traveling direction and the remained distance will be described with reference to FIG. 6.

Hereinafter, an example of using a pen type device with a navigation apparatus (portable terminal) mounted on a vehicle will be described.

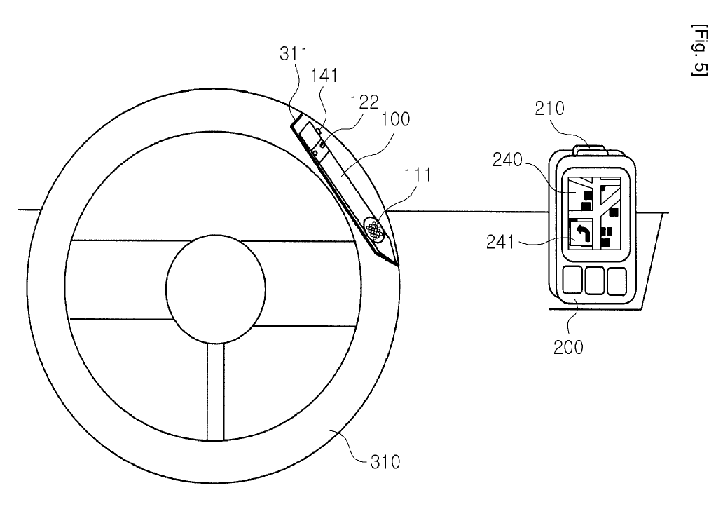

FIG. 5 is a diagram illustrating a terminal and a pen type device mounted at the wheel of a vehicle according to an embodiment of the present invention.

Referring to FIG. 5, the pen type device 100 is mounted at a groove 311 formed at the wheel 310 of a vehicle, where a user's finger can reach easily. The terminal 200 is mounted at a position allowing the user to easily watch a map displayed thereon. The terminal 200 may be, however, mounted at a position block from the user's sight because the user can receive the voice navigation service from the terminal 200 rather than watching the traveling direction 241 of the map displayed on the display unit 240 of the terminal 200.

The wireless communication unit 210 of the terminal 200 transmits a direction, a distance, peripheral information, and safety (warning) information, which are obtained based on a current location, to the wireless communication unit 140 of the pen type device 100.

Then, the controlling unit 150 of the pen type device 100 analyzes the received information from the wireless communication unit 140, and controls the vibrator 130 and the electric pump 213 according to the corresponding information. The vibrator 130 provides vibration to a user by driving corresponding pins 111 of the texture reproducing unit 110 to make vertical movement according to the tactual information in response to the control of the controller 150.

The electric pump 213 receives the olfactory sense information from the controlling unit 150 and sprays a predetermined fragrance. A method of using the tactual information provided to the texture reproducing unit 110 will be described with reference to FIG. 6.

Referring to FIG. 6, the texture reproducing unit 110, as described above, includes a plurality of pins, moves each of the pins in vertical direction, and controls the displacement of the vertical direction. For example, the displacement of the vertical direction can be decided to be a maximum height 414, a minimum height 415, and an intermediate height 416. The displacement of the vertical direction may be controlled at various heights according to an input electric signal. Furthermore, the texture reproducing unit 110 can control the pins to make vertical reciprocating motion with a predetermined frequency. That is, the texture reproducing unit 110 can vibrate the pin arrangement (pattern) itself in a vertical direction to accurately transfer the tactual information. Such a vertical reciprocating motion frequency is a frequency allowing a user to easily feel the pattern. Therefore, the vertical reciprocating motion frequency can be adjusted according to an individual user. Generally, the frequency is selected from about 0 to 30 Hz. However, the frequency range can be widened according to an exceptional user. It is a reason of vibrating the pin pattern itself to transmit the tactual information that the nerve cell receptors of human, which feel the pattern, become most sensitive at a frequency lower than 10 Hz, particularly, about 0.5 to 3 Hz according to the tactual characteristics of the human.

The texture reproducing unit 110 can transfer control signals, for example, go-straight 410, left-turn 411, right-up 412, and stop 413, according to the received tactual information received from the terminal 200 in response to the control of the controlling unit 150.

Hereinafter, a method for providing a navigation service to a user through a pen device and a terminal according to an embodiment of the present invention will be described with reference to the accompanying drawings.

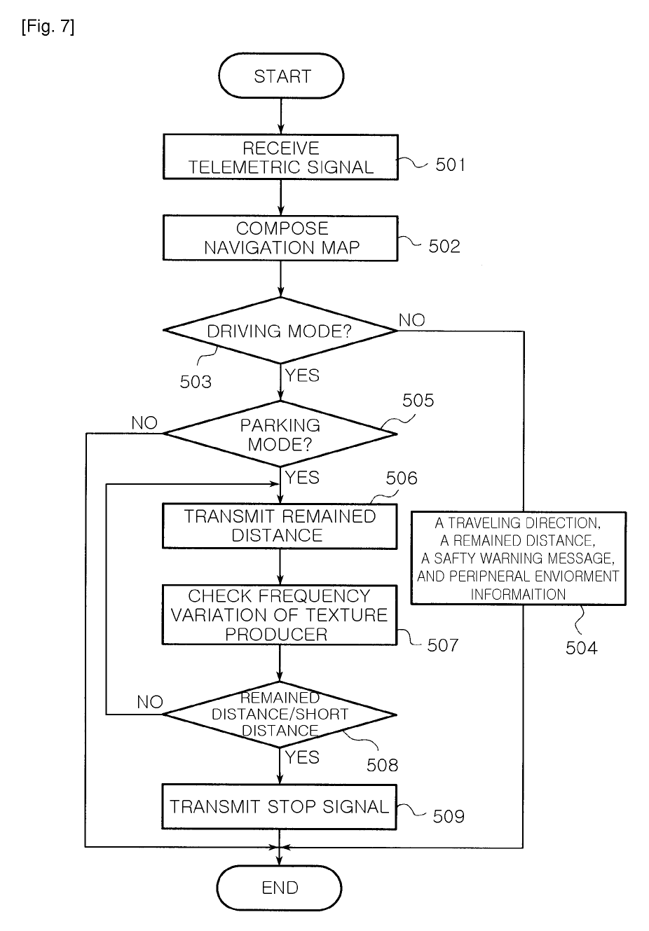

FIG. 7 is a flowchart illustrating a method for providing a navigation service according to an embodiment of the present invention.

Referring to FIG. 7, a terminal 200 is connected to a telemetric system through the Internet and collects information about the navigation service by receiving a telemetric signal from the telemetric system at step S501. Then, the terminal 200 detects a current position, a current speed, and a traveling path using the received telemetric signal and the collected information and creates a navigation map according to the detecting result at step S502. The terminal 200 displays the created map on the display unit 240 and displays the direction 241 with the traveling path, thereby providing visual navigation service. The terminal 200 also provides voice navigation service by transforming the visual navigation information to the voice navigation information. Herein, the received telemetric signal may include various information related to traffic and safety information such a dangerous area, high speed warning, falling rock warning, and freezing warning.

The terminal 200 determines whether a user or a driver is in driving or not at step S503. That is, if a current mode is the driving mode, the terminal 200 creates a traveling direction, a remained distance, a safety warning message, and peripheral environment information using the collected information, and transmits the created information to the pen type device 100. Then, the terminal 200 terminates the relate operations at step s504.

The pen type device 100 receives the information such as the traveling direction and the remained distance, and transfers the received information to the texture reproducing unit 110. As shown in FIG. 5, the pen type device 100 creates directional stimulation patterns 410 to 413. The information about the remained distance may be information about a distance remained until making a turn or stopping. In order to transfer the remained distance, the pen type device 100 moves the pin arrangement in vertical direction, vibrates the pin arrangement, and changes the amplitude and the frequency thereof. Then, the pen type device 100 moves the pins of the texture reproducing unit 110, which are projected with a predetermined pattern, in vertical direction. As a destination is getting closer, the pen type device 100 increases the frequency and the amplitude of the vibration of the vertical movement of the pins. That is, the driver recognizes that a time to make a turn or to stop is getting closer by receiving greater stimulation without watching the map displayed on the terminal or without being disturbed by peripheral noise.

The pen type device 100 also intuitively transfers the traffic safety information (warning) such as a high speed zone, a sharp turn corner, and a bad road condition by controlling the vibrator 211 to increase vibrating motion, for example, the number of making vibrating motion. For example, the pen type device 100 controls the vibrator 211 to make vibrating motion for three seconds and stop for one second in order to inform a dangerous area, to make vibration for one seconds and stop for three seconds in order to inform the high speed zone, to make vibration for one seconds and stop for one second in order to inform falling rocks, to make vibration for three seconds and stop for three seconds in order to inform the freezing area, and to make vibration for 0.5 seconds and stop for 0.5 second in order to inform approaching vehicle.

The pen type device 100 also receives peripheral environment information with the fragrance information of peripheral buildings, and sprays corresponding fragrances to a user or a driver. For example, if a coffee shop is included in a traveling path to a predetermined destination, the peripheral environment information previously is set to spray a predetermined fragrance corresponding to the coffee shop such as coffee fragrance. When the controlling unit 150 receives the peripheral environment information included in the olfactory sense information from the terminal 200, the controlling unit 150 extracts fragrance information corresponding to the received peripheral environment information and transfers the extracted fragrance information to the fragrance generating unit 120. Then, the electric pump 123 of the fragrance generating unit 120 sprays the coffee fragrance according to the fragrance information through the fragrance outlet 122 using the pressure difference. Accordingly, the driver or the user intuitively recognizes that the driver is passing by the coffee shop without looking around the peripheral environment. If the user checks a destination or intermediate points with related fragrance information before departure, the user can conveniently recognize the destination or the intermediate points. The pen type device 100 can be set with various fragrance information, for example, camphor fragrance for a factory, and a flower fragrance for a park. Such an idea can be applied to compose a map with fragrances. When a map is created, information about shops and buildings related to unique fragrance, such as restaurant, gas station, flower shop, coffee shop, hospital, and bakery, are putted into the map according to the requests of clients, thereby maximizing the advertisement effect.

Meanwhile, if the current mode is not the driving mode at step S503, it determines whether the current mode is a parking mode or not. If the current mode is no the parking mode, the related operation is terminated. If the current mode is the parking mode, a step S506 is performed.

At the step S506, the terminal 200 transmits the remained distance information to the pen type device 100. Then, the pen type device 100, as described above, drives the pins 111 of the texture reproducing unit 110 to make the vertical movement using the remained distance information. At step s507, the terminal 200 checks the frequency variation of the texture reproducing unit 110. At step S508, a remained distance and a safety distance are compared with each other. If the remained distance is shorter than the safety distance, at step s509, the terminal 200 transmits a stop signal to the pen type device 100. On the contrary, if the remained distance is longer than the safety distance, the remained distance is checked and transmitted to the pen type device 100 at step S506. Then, the above described operations are repeatedly performed.

While the present invention has been shown and described in connection with the preferred embodiments, it will be apparent to those skilled in the art that modifications and variations can be made without departing from the spirit and scope of the invention as defined by the appended claims.

1. A method for providing navigation service comprising:
receiving tactual information created according to navigation information displayed on a navigation map composed by a terminal based on collected navigation information; and
controlling a plurality of pins to make vertical movements according to a directional stimulation and frequency amplitude variation obtained from the received tactual sense information.

2. The method according to claim 1, further comprising:
receiving olfactory sense information created according to the navigation information displayed on the created navigation map from the terminal; and
spraying a predetermined fragrance corresponding to a peripheral environment to the user using the olfactory sense information.

3. The method according to anyone of claim 1 and claim 2, further comprising:
checking safety information from the tactual sense information and generating warning vibration according to the safety information; and
vibrating the plurality of pins that make the vertical movement according to the warning vibration

4. The method according to claim 3, wherein the step of vibrating the plurality of pins comprises:
providing a distance remained until making a turn or stopping, which is included in the tactual sense information, using vibration amplitude and frequency modulation of the vertical movement; and
increasing the vibration amplitude and the frequency modulation as the remained distance becomes closer.

5. The method according to claim 5, wherein the plurality of pins form a predetermined pin arrangement (pattern) and the predetermined pin arrangement is vibrated according to a frequency lower than about 30 Hz so as to stimulate a tactual sense of the user.

6. A method for providing navigation service at a terminal comprising:
at a terminal for a navigation service, creating a navigation map by collecting information for the navigation service;
performing the navigation service by providing visual and voice information created based on navigation information displayed on the created navigation map;
creating and combining tactual and olfactory sense information according to the navigation information displayed on the created navigation map; and
transmitting the combined tactual and olfactory sense information to a pen type device for providing a navigation service to the user by stimulating the senses of the user according to the created tactual and olfactory sense information.

7. The method according to claim 6, further comprising:
transmitting a remained distance included in the tactual and olfactory sense information when a user makes a turn or stops;
checking frequency variation of a texture reproducing unit according to the remained distance; and
comparing the remained distance and a safe distance, and transmitting a stop signal to the pen type device if the remained distance is shorter than the safe distance.

8. The method according to claim 6, wherein the tactual and olfactory sense information includes a traveling direction, a remained distance, safety information, and peripheral environment information.

9. An apparatus for providing a navigation service comprising:
a terminal,
wherein the terminal comprises:
a controlling unit for collecting information for navigation service and creating a navigation map according to the collected information;
a display unit for displaying navigation information at the created navigation map;
a speaker for informing the navigation information displayed on the navigation map through voice;
an information generating unit for generating the navigation information displayed on the navigation map as tactual and olfactory sense information; and
a wireless communication unit for transmitting the tactual and olfactory information to a pen type device for providing a navigation service to the user according to the created tactual and olfactory information.

10. The apparatus according to claim 9, further comprising an information combining unit for combining the created tactual and olfactory sense information and transferring the combined information to the wireless communication unit.

11. The apparatus according to claim 9, wherein the controlling unit transmits a remained distance included in the tactual and olfactory sense information to the pen type device when making a turn or stopping, checks frequency variation of a texture reproducing unit for stimulating a tactual sense of the pen type device, compares the remained distance and a safe distance, and transmits a stop signal to the pen type device if the remained distance is shorter than the safe distance.

12. The apparatus according to anyone of claims 10 and 11, wherein the tactual and olfactory sense information includes a traveling direction, the remained distance, safety information, and peripheral environment information.

13. An apparatus for providing a navigation service comprising:
a pen type device,
wherein the pen type deivce comprises:
a wireless communication unit for receiving tactual sense information from a terminal that creates a navigation map by collecting information for a navigation service and transmits tactual sense information created according to navigation service information displayed on the created navigation map;
a texture reproducing unit for arranging a plurality of pins on a predetermined plane, and stimulating a tactual sense of a user by driving corresponding pins to make vertical movement according to traveling direction information obtained from the received tactual sense information; and
a controlling unit for controlling the vertical movement of the corresponding pins by transferring traveling direction information to the texture reproducing unit.

14. The apparatus according to claim 13, further comprising a plurality of pin motors disposed corresponding to the plurality of pins for driving corresponding pins to make vertical movement in response to the control of the controlling unit.

15. The apparatus according to claim 14, wherein the pins making the vertical movement form a predetermined pin arrangement (pattern), stimulates the tactual sense of the user, and the pin arrangement is vibrated according to a frequency lower than about 30 Hz.

16. The apparatus according to anyone of claims 13 and 14, further comprising a vibrator for generating warning vibration to the user by vibrating the pins according to safety information transmitted from the terminal in response to the control of the controlling unit.

17. The apparatus according to claim 13, further comprising a fragrance generating unit for spraying fragrances according to peripheral environment to the user using olfactory sense information received from the terminal, where the fragrances are previously stored according to previously set fragrance information.

18. The apparatus according to claim 16, wherein the controlling unit control the vibrator for vibrating the pins that make the vertical movement, checks a remained distance included in the tactual sense information until making a turn or stopping using vibration amplitude and frequency modulation of the pins making the vertical movement, and increases the vibration amplitude and frequency modulation as the remained distance is getting closer.
